(19) United States
(12) Patent Application Publication
(10) Pub. No.: US 2010/0310338 A1
(43) Pub. Date: Dec. 9, 2010

(54) SPEED NUT

(75) Inventor: Victor Diez Herrera, Barcelona (ES)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ITW METAL FASTENERS, S.L., Barcelona (ES)

(21) Appl. No.: 12/740,128

(22) PCT Filed: Nov. 25, 2008
(86) PCT No.: PCT/IB2008/003206

§ 371 Date: Apr. 28, 2010

(30) Foreign Application Priority Data
Nov. 29, 2007 (ES) 200703222

(51) Int. Cl. F16B 37/00

(52) U.S. Cl. 411/432

(57) ABSTRACT

This invention describes a speed nut that is formed by three surfaces, a lower surface that is a coupling washer to be pressed against the panel or protective device to which it is attached, an intermediate or base surface, and a final surface that is formed by an arm which, folded back on itself, covers the center of the nut. These surfaces have central holes whose centers are vertically aligned. The nut of the invention has a double screw thread, which consists of the conventional thread of the surface or upper arm and of another thread that is present on the base surface. Both screw threads are created by means of cuts that produce independent flanges of different sizes which together form a helical outline that is designed to mate with the corresponding threading of the screw or bolt that will pass through said nut.

### SCOPE OF THE INVENTION

This invention pertains to a speed nut, of the type that is used to fasten sheets or panels, with the characteristic that it provides a reserve elastic action and has double threading to prevent over-tightening and that it incorporates a washer to improve the nut's contact surface.

### BACKGROUND

Especially with its extensive use of insulation panels and protective sheets or plates, the automotive industry has needed means of quickly attaching such parts. Moreover, the cladding of, for example, a coating to the bottom of a car body can be a complex and difficult task.

For this kind of nut, the procedure of the state of the art begins with a threaded screw or bolt that is fastened to a support plate on which the panel or heat shield to be attached is located. The nut is screwed onto the screw to match the surface of this panel. The nuts have a hexagonal outer shape to make it possible to use a specific pneumatic tightening tool or, if such a tool is not available, a nut wrench or open-end wrench of the appropriate size.

This is the case of the Spanish industrial models I0144504 and I0142806, which call for corresponding nuts in the shape of hexagonal bowls of different designs which essentially create a passage for the attachment nut whose threading locks in the segmented flanges that are arranged in a circle around a central hole through which said screw passes.

Another example of this kind of embodiment is found in European patent EP0970313, in which an elastic nut is formed by bending on itself a bridge facing toward the base of the nut and the flanges enclosing the screw, such that when the nut is attached to the bolt, there is a small amount of elastic play between the pressure of the bridge on the base of the nut and said flanges against the threading of the bolt. To operate exactly as it should, this embodiment requires that the length between the bridge and the edges of said flanges be equivalent to the pitch of the threading.

For speed nuts of this type, it can be stated in general that—aside from the properties that are inherent in the nature of their materials such as stress resistance, the nut's hardness, its strength at elevated temperatures, and the cost of such nuts—efforts to improve their performance currently relate to developing a better elastic response, which would translate into better performance of the nut in the presence of the vibrations/shocks that it will experience due, for example, vehicle vibrations, as well as easier installation.

Thus, to make these nuts simple to use, they often are situated in such a way that the user can, in a few steps, install each nut in its proper place. In addition, the current installation processes, which call for power tools that deliver an elevated tightening torque without effort on the part of the user, may occasionally cause problems when these kinds of nuts are installed, mainly due to over-tightening, which causes them to deteriorate, on occasion creating the danger that they may break or may suddenly and violently pop off and be hurled into the surrounding area.

The object of this invention is to ensure better performance in these regards, safety, simplicity of use, and a better response to variations in the optimum tightening of the nut. These and other advantages of this invention will emerge from the description of said invention.

### BRIEF EXPLANATION OF THE INVENTION

This invention describes a speed nut that is formed by three surfaces, a lower surface that is a coupling washer to be pressed against the panel or protective device to which it is attached, an intermediate or base surface, and a final surface that is formed by an arm which, folded back on itself, covers the center of the nut. These surfaces have central holes whose centers are vertically aligned.

The edge of the washer or lower surface is beveled upward, toward the nut, thus keeping it from rubbing against the protective device or panel to which it is attached.

The central or base surface has cuts that delimit feet that support said base on the body of the washer, thereby creating an elastic resistance to the deformation and tightening of the nut.

The nut of the invention has a double screw thread, which consists of the conventional thread of the surface or upper arm and of another thread that is present on the base surface. Both screw threads are created by means of cuts that produce independent flanges of different sizes which together form a helical outline that is designed to mate with the corresponding threading of the screw or bolt that will pass through said nut.

Rising from its base surface, the nut has corresponding vertical walls that are independent of one another and that form a hexagonal outline designed to fit a conventional nut wrench or specific pneumatic tool for tightening the nut of the invention with a hexagonal head.

With the elements that are present in the nut of the invention, the intended objects have been achieved, i.e., to provide an elastic speed nut that makes it possible to deal with the vibrations of the environment in which it is used, ensuring a better response to over-tightening due to the double threading, which makes it more difficult for the nut to break.

### BRIEF EXPLANATION OF THE DRAWINGS

To ensure better understanding, a sheaf of drawings is attached that illustrates the invention in one of its possible embodiments, whereby said drawings do not limit the scope, possibilities, or object of the invention.

FIG. 1 shows a perspective view of a speed nut according to this invention in its preferred embodiment.

FIG. 2 is a bottom plan view of the nut of FIG. 1.

FIG. 3 is a front elevation view of the nut according to the previous figures.

FIG. 4 shows a side view but with the nut of the previous figures rotated 90 degrees relative to the view of FIG. 3.

FIG. 5 shows a top view of the nut according to the preferred embodiment of the invention, while FIGS. 6 and 7 show corresponding cross-sections through this view.

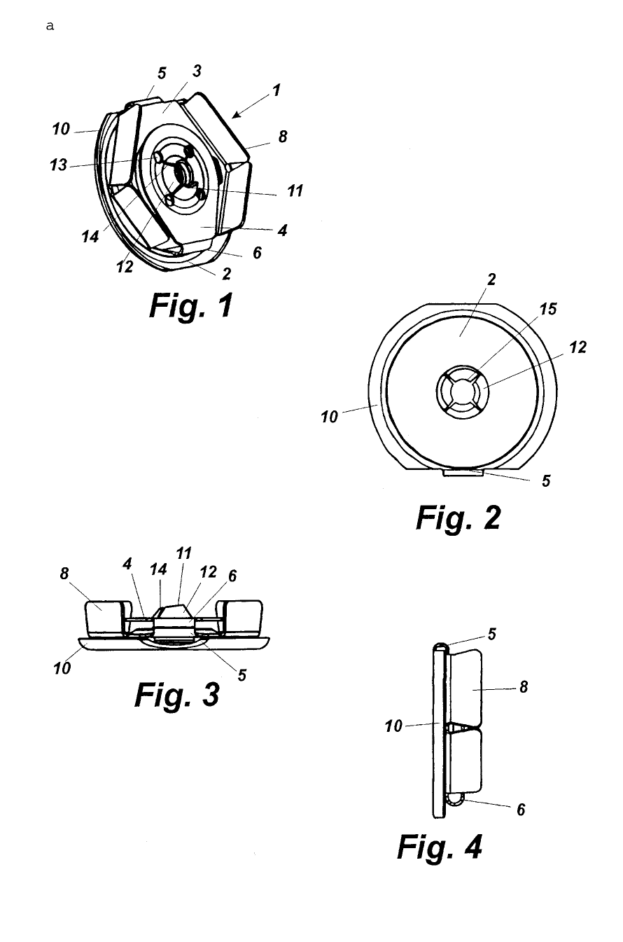

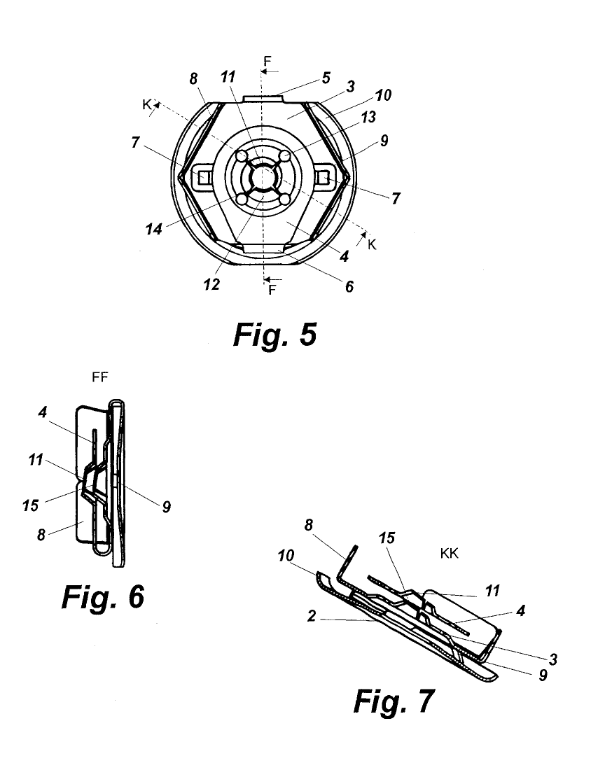

### DETAILED EXPLANATION OF THE INVENTION

This invention pertains to a speed nut of the type that is used to attach protective covers and panels, whereby said nut is made from a laminar metal surface by stamping and deformation and whereby it is generally hexagonal in shape so that it can be used with a nut wrench; said nut is applied against a screw or bolt and compresses said protective cover.

The nut (1) has a base part, a flexible-arm part, and a part consisting of perimeter walls, whereby said parts have central holes through which said nut passes.

Said flexible-arm part has a hole with perimeter screw threading (11) that is designed to mate with the threading of said screw or bolt.

In addition, said speed nut (1) has a lower surface or washer (2) with perimeter edges (10) that are raised in the direction of the body of said nut (1), as well as a second thread (15) in said base surface (3) that is also designed to mate with said screw or bolt.

The design of the preferred embodiment of the invention is based on a steel plate which, stamped by conventional means, is bent by means of two folds (5 and 6) to produce three surfaces. The lower surface, which is said washer (2), is flat with a beveled perimeter edge to avoid damaging the protective cover to which it is attached.

The intermediate or base surface (3) of the speed nut (1) has four independent walls (8) that rise orthogonally from said base (3), together forming a hexagonal-finish nut that can be used both with specific pneumatic tightening tools and with conventional nut wrenches, as the case may be.

As the sections of FIGS. 6 and 7 show, in its central hole said base surface (3) has corresponding flanges (12) with a helical profile (15) that is designed to mate with the threading of the screw or bolt that runs through the nut.

There are some cuts (9) in the material of the base (3) that define feet (7) which, when bent downward, form an elastic gap with respect to said lower washer (2).

For its part, the upper edge has an arm (4) that extends over the body of the nut, also having a central hole whose center is vertically aligned with the corresponding centers of the lower surfaces (2 and 3), whereby said central hole has a helical threading (11) that is designed to mate with the threading of the screw or bolt.

Said threading (11) is created by means of corresponding independent flanges (12) of different sizes which, when arranged, together form a helical perimeter and four flanges (12) in the preferred embodiment of the invention, with circular separators (13) at the ends of their bases and cuts (14) that form their protruding sides.

Thus, with the speed nut of this invention, said washer (2) improves the contact surface between the protective cover and the speed nut (1). At the same time, the design of this invention represents an improved elastic response on the part of said nut (1). In addition to the elastic action of the upper arm (4), this speed nut (1) has both (a) feet (7) that act elastically on the base (3) and (b); the action, also elastic, of the different flanges (12) when it acts against the threading of the screw or bolt that passes through the nut.

In addition, the double thread of the nut of the invention, the built-in threading of the base surface (3) and the threading of the upper arm (4), do represent an improved mating of this kind of nut with the screw that passes through it.

The most direct result of this elastic performance on the part of the speed nut (1) according to this invention is, on the one hand, to keep the part from becoming accidentally unscrewed when it is affixed to a vehicle. In addition it is, thanks to the double threading, the increase in the failure torque of the screw (1), increasing the margin of safety in its use compared to the tightening torque employed to affix it.

It is understood that in the present case there can be variations such as details of the head and shape that do not alter the essence of the invention.

1. SPEED NUT, of the type used to attach protective covers and panels, whereby said nut is made from a laminar metal surface by means of stamping and deformation, whereby said nut is generally hexagonal in shape so that it can be used with a nut wrench; said nut is applied against a screw or bolt and compresses said protective cover; said nut has a base part, a flexible-arm part, and a perimeter-wall part; said parts have central holes passing said nut; in said flexible-arm part, said nut includes a perimeter threading that is designed to mate with the threading of said screw or bolt, characterized by the fact that, in said speed nut, in addition to said upper flexible-arm part that is connected by a fold to said base part, a lower surface or washer is connected to said base by means of a fold, whereby the corresponding holes of each surface are vertically aligned with respect to their center points; there are two sets of threadings that are designed to mate with the threading of the screw or bolt that passes through said nut, a first thread in the hole of said base surface and a second, upper threading in the hole of said upper arm; the two threads form a helical threaded perimeter, defined by flanges that are independent and of different sizes; whereby cuts in the material of said base define feet which, folded downward, provide an elastic gap with respect to said lower washer.

2. SPEED NUT, according to claim 1, wherein said washer has a beveled perimeter edge that rises toward the body of said nut.

3. SPEED NUT, according to claim 1, wherein said upper threading is formed by means of corresponding independent flanges of different sizes that are arranged so as to form a complete helical perimeter, with circular separators at the ends of their bases and cuts that form their protruding sides.

4. SPEED NUT, according to claim 1, wherein there are four of said flanges in each of said surfaces, the base surface and the upper arm surface.

5. SPEED NUT, according to claim 1, wherein four independent walls rise orthogonally from said base, together forming a nut whose perimeter shape is approximately hexagonal.
